(19) United States
(12) Patent Application Publication
(10) Pub. No.: US 2026/0008020 A1
(43) Pub. Date: Jan. 8, 2026

(54) ULTRASONIC INFUSION DEVICE

(71) Applicant: R-TECH4 SRL, Lasne (BE)

(72) Inventor: Roger COCLE, Lasne (BE)

(73) Assignee: R-TECH4 SRL, Lasne (BE)

(21) Appl. No.: 18/766,105

(22) Filed: Jul. 8, 2024

(51) Int. Cl. B01F 31/87; A47J 31/44; B01F 23/50; B01F 31/86; B01F 101/14; B01F 101/16; C12G 3/06

(52) U.S. Cl. CPC B01F 31/87; A47J 31/4403; B01F 23/551; B01F 31/86; C12G 3/06; B01F 2101/14; B01F 2101/16

(57) ABSTRACT

The invention relates to an ultrasonic infusion device comprising an ultrasonic wave generator, a basin physically connected to the ultrasonic wave generator to form a rigid assembly and wherein said basin is arranged to comprise an ultrasound-conducting liquid, and an infusion container comprising a base, wherein vibration absorbing means are mounted between the rigid assembly and a container carrier, and wherein the base of the infusion container is dimensioned to be supported by the container carrier and is shaped to ensure continuous contact with the ultrasound-conducting liquid.

### FIELD OF THE INVENTION

The invention relates to the field of ultrasonic infusion of components comprised within non-liquid edible ingredients such as fruits, vegetables and/or other plants into a liquid. In particular, it relates to an ultrasonic infusion device for preparing flavoured beverage and to its use.

### BACKGROUND TO THE STATE OF THE ART

The use of ultrasound to infuse edible ingredients such as fruit, vegetables and/or other plants into a liquid is well known in the food industry. Indeed, whereas a ‘natural’ or passive infusion at cold temperatures usually takes several hours for mediocre extraction, use of ultrasounds speed this process up. As a general rule, high-intensity, low-frequency ultrasound waves create tiny vacuum bubbles in the liquid. These tiny bubbles grow rapidly over several cycles of rarefaction and compression. When the cavities reach such a size that they can no longer absorb energy, they implode violently, creating the phenomenon of acoustic cavitation. The energy created by the collapse of the bubbles is used to extract the aromas from plants and vegetables, then to dissolve and incorporate the aromas and ingredients into the liquid with greater efficiency in a very short time. Ultrasound can therefore be used to quickly infuse drinks or beverage with a rich flavour profile.

This process is applied at industrial scale, within large reactors. However, very few possibilities have been disclosed for domestic applications.

There are several techniques for generating and transmitting ultrasound to the liquid to be infused. In particular, there are ultrasound probes, placed directly in the liquid, or ultrasonic baths in which an ultrasonic waves generator is connected to a basin to transmit ultrasound directly to the contents of the basin.

WO20231964404A1 discloses a domestic device comprising a container and a based arranged to be screwed together to create close physical contact between the two. However, when surfaces of two rigid objects are designed to be closely in contact, this contact is rarely perfect and the interface allows air gaps, which lower the ultrasound transmission efficiency and generate vibrations. In this document, an antenna is further implemented in the container to ensure a good homogeneity of the ultrasound within the solution to be infused.

Other devices use a liquid (water) as an intermediate medium for conducting ultrasonic waves between the wave generator and any object that is not directly physically connected to the wave generator. Indeed, a conducting liquid can fill any gaps in conductivity between the surfaces to ensure the efficient transfer of ultrasonic waves. In the case of ultrasonic baths, the wave generator is connected directly to a basin, which is then filled with a conducting liquid or gel so that the container in which extraction is happening is immersed in the liquid. The container usually relies on the bottom of the basin.

In particular, US20200148985A1 discloses for example an electronic infusion device for infusing a liquid substance by ultrasound bath. An infusion container is arranged to be deposited directly in a basin comprising a conductive liquid and subjected to vibration when the wave generator is operating. In such devices, intended for domestic use, a problem of stability and vibration occurs, as the container has a degree of freedom to move within the basin. A significant amount of energy is thereby lost which reduces the efficiency of the infusion, generates unpleasant noise and leads to wear of the container.

The applicant therefore deemed it necessary to develop an ultrasonic infusion device to overcome at least some of these problems.

### Solution of the Invention

To this purpose the invention relates to an ultrasonic infusion device comprising:
An ultrasonic wave generator,
A basin physically connected to the ultrasonic wave generator to form a rigid assembly and wherein said basin is arranged to comprise an ultrasound-conducting liquid, and
An infusion container comprising a base,
   said device being characterised in that
   it comprises vibration absorbing means which are mounted between the rigid assembly and a container carrier, and wherein the base of the infusion container is dimensioned to be supported by the container carrier and is shaped to ensure continuous contact with the ultrasound-conducting liquid.

The ultrasonic infusion device of the invention allows the base of the infusion container to be in continuous contact (i.e. without air gaps or bubbles) with the conducting liquid for optimal transmission of the ultrasonic waves to the content of the infusion container where infusion should take place, without having to directly deposit the infusion container in the basin, thereby avoiding loss of energy in vibrations when the ultrasonic wave generator is operating. In this way, the infusion container is completely stable, and the vibrations of the basin are not transmitted to it. The device can also have a very low noise level and the infusion container is not subjected to the wear induced by friction between the basin and the contained resulting from the vibrations.

### Wave Generator

The ultrasonic wave generator may be any type of generator capable of an generating ultrasonic waves, such as electrostrictive transducer. To operate it, the generator is connected to an electronic card, as is well known to a person skilled in the art. The ultrasonic wave generator can, for example, be a piezoelectric transducer comprising electrodes placed on either side of a piezoelectric material. Alternatively,

As a general principle, the lower the frequency of the ultrasound generated by the ultrasonic wave generator, the more efficient the infusion. On the other hand, the frequency should not be too low to avoid audible frequencies. A compromise must be found between efficiency and user comfort. The ultrasonic wave generator is preferably arranged to emit waves between 20 and 100 kHz, preferably between 22 and 60 kHz, preferably between 25 and 40 kHz, even more preferably around 28 kHz for optimum infusion of the larger spectra of fruits, vegetables and/or other plants.

Ideally, the power of the ultrasonic wave generator is comprised between 10W and 200 W per litre of liquid to be infused, preferably between 20W and 150W, preferably between 40W and 80W, even more preferably around 60W per litre of liquid contained in the infusion container. This provides a good compromise between efficient infusion and avoiding heating the liquid. Indeed, generating heat in the infused liquid may lead to degradation of certain extracted species. Further, the device allows fast on demand infusion of beverages for direct consumption, and the infused liquid should be directly drinkable without the need to add ice.

### Basin

The basin is physically connected to the ultrasonic wave generator to form a rigid assembly, for example by glueing and/or screwing, or by any other means known to a skilled person in the art enabling two parts to be physically connected together, such as bolting, welding, etc. This means, an effective surface of the ultrasound generator is contacting perfectly a surface of the basin to form said “rigid assembly”. As a result of this rigid assembly, the ultrasounds generated by the ultrasonic wave generator are completely transmitted to the basin.

For the sake of durability, the basin is preferably resistant to deterioration under the effect of ultrasound. Preferably, the basin is made of stainless steel, preferably 304L or 316L stainless steel. Alternatively, it can be made of metal such as steels, titanium or any other material known to a person skilled in the art to be resistant to deterioration under the effect of ultrasound.

The device must be able to transmit ultrasound from the rigid assembly to the infusion container, which is not physically connected to the rigid assembly, in the most efficient way possible. In this respect, the basin is arranged to comprise an ultrasound-conducting liquid. Indeed, it is important that a liquid is used as an ultrasonic conductor between the rigid assembly and the infusion container that is not directly physically connected to the rigid assembly. Even if surfaces of the basin and the infusion container are designed to be flat, they cannot be completely flat without very high-precision and very expensive shaping. The ultrasound-conducting liquid fills any gaps in conductivity between the surfaces to facilitate the efficient transfer of ultrasonic waves.

Preferably, the basin is designed as a watertight entity with a bottom and sidewalls extending upwards on the whole perimeter of the bottom. Preferably, the bottom has a round shape, and the side walls form a cylinder having an upper edge. The round shape is the best for homogeneity of ultrasound diffusion but is not mandatory.

For ease of use and efficient transmission, the ultrasound-conducting liquid is preferably water. Alternatively, the ultrasound conducting-liquid can be any other liquid or gel preferably having advantageous properties regarding its ultrasound conductivity.

### Infusion Container and Vibration Absorbing Means

The infusion container is not physically connected to the rest of the device. It is arranged to contain a liquid, for example water, oil or alcohol, and edible ingredients such as fruits, vegetables and/or other plants. The infusion container or infusion container is meant to be the final destination of the ultrasonic waves.

The device according to the invention does not provide for the infusion container to be deposited directly in the basin. This is because, according to the invention, the infusion container must not be allowed to move and come into contact with the bottom and the walls of the basin, which are subject to the vibrations generated by the ultrasonic wave generator. If the infusion container vibrates, the efficiency of ultrasound transmission to the inside of the infusion container is reduced, as is user comfort.

To this purpose, the device comprise a container carrier or support means for the infusion container.

Accordingly, to physically connect the rigid assembly, which is potentially subject to vibration, to the container carrier without transmitting the vibratory movement, the device comprises vibration absorbing means which are mounted between the rigid assembly and the container carrier. In some cases, the container carrier and the vibration absorbing means can be merged into a single element, such as a seal or rubber joint.

The vibration absorbing means may comprise seals, bumpers, dampers, etc.

To deposit the infusion container on the container carrier without transmitting vibratory movements to it, the base of the infusion container is preferably dimensioned to be supported by the container carrier. Depending on the geometry of the container carrier, the dimension of the base of the infusion container must be adapted so that it can be placed on the container carrier. For example, if the container carrier has an annular geometry, the base of the infusion container must be large enough to rest and be stable on the container carrier. In this way, the infusion container can be placed on the device without being subjected to the vibratory movements generated by the ultrasonic wave generator.

At the same time, the container carrier must be positioned in the device such that, when the infusion container rests on it, the base of the infusion container lies at a non null height above the bottom of the basin, but below the top edge of the basin. This means that the base of the infusion container can be continuously contacting the ultrasound conducting liquid within the basin, provided that the user has placed the suitable amount of liquid in the basin. Ideally, when the infusion container is positioned on the container support, there is a thickness of ultrasound-conducting liquid between the base of the infusion container and the base of the basin of between 1 mm and 10 mm, preferably between 2 mm and 7 mm, still preferably of around 5 mm.

The container carrier may be one single element able to support the infusion container or may comprise a plurality of elements which together support the infusion container.

Advantageously, the container carrier may comprise portion further extending to form a stand on the surface on which the device is placed. In this way, vibrations are not transmitted either to the infusion container or to the surface on which the device is placed, ensuring more efficient infusion and greater comfort for the user.

The container carrier preferably is part of a housing for the device. The rigid assembly is connected thereto by vibration absorbing means, meaning fixation means which comprise some vibration absorbing element. To protect the user of the ultrasonic wave generator, the housing encloses the rigid assembly and comprises a top opening defined by a top edge. The top edge surrounds the walls of the basin without directly touching them so that a layer of air remains between the basin and the housing. This layer of air, which is a poor conductor of ultrasound compared to a liquid, prevents ultrasound from being transmitted to the housing in order to optimise the infusion efficiency. The top edge of the housing is designed to support the base of the infusion container. The top edge of the housing is then the container carrier.

Ideally, to place the infusion container on the container carrier without the risk of it slipping and falling off, the container carrier comprises a non-slip or grippy surface for the infusion container to be placed on. Preferably, the grippy surface is also soft to attenuate any vibrations that may remain despite the vibration absorption means. Typically, a seal, preferably a rubber seal, may be suitable. Advantageously and optionally, the seal further serves as an watertight seal between the container carrier or the housing and the basin. Preferably, the seal is designed with an annular groove to accommodate the edge of the basin, so that the basin, potentially in vibration, can slide in the seal so as to be leak tight for the ultrasound-conducting liquid.

Advantageously, the seal alternatively of additionally comprises a hollow space enclosed therein to further prevent ultrasound being lost through it.

To efficiently transmit the ultrasound generated by the ultrasonic wave generator to the infusion container, the base of the infusion container is shaped to ensure continuous contact with the ultrasound-conducting liquid. Continuous contact means that the entire lower surface of the base of the infusion container is in contact with the ultrasound-conducting liquid, there are no gaps that could block ultrasound transmission and reduce the efficiency of the infusion. The shape of the base must also maximise the contact surface with the ultrasound-conducting liquid.

The base may, for example, be convexly shaped so that its sides or edge rest on the container carrier and its convex part is in continuous contact with the ultrasound-conducting liquid. For example, the infusion container has a bottle shape or an Erlenmeyer with a flat bottom with a rounded edge forming the base. The edge lies on the carrier which allows the flat bottom to be at a slightly lower level and be in the basin to contact the liquid.

For good ultrasound conduction, the infusion container may be made of glass or glass derivative. Alternatively, any other material resistant to deterioration under the effect of ultrasound may be suitable.

Advantageously, when the infusion container is glass, the outer surface of its base can be sandblasted to be blurred when dry but become transparent when it comes into contact with liquid. This enables the user, when placing the infusion container on the container carrier, to check that the base of the infusion container is properly in continuous contact with the ultrasound-conducting liquid. If the base of the infusion container is not completely transparent, this indicates to the user that there may be bubbles or that there is a lack of ultrasound-conducting liquid in the basin, or perhaps that the container is incorrectly positioned. In some cases, a marker may be printed on the bottom of the basin, which becomes visible when the sandblasted glass becomes transparent upon correct placement of the infusion container.

Optionally, the shape of the infusion container can be designed to redirect ultrasound towards the centre of the infusion container to increase infusion efficiency. Preferably, the infusion container has a conical shape, like for example an Erlenmeyer shape, to redirect the ultrasound into the centre of the infusion container, thereby improving infusion homogeneity.

Optionally, the device according to the invention comprises a switch for activating or deactivating the ultrasonic wave generator. The switch may further comprise a timer to control the duration of the infusion.

### DETAILED DESCRIPTION OF THE INVENTION

The invention will be better understood with reference to the drawings where:

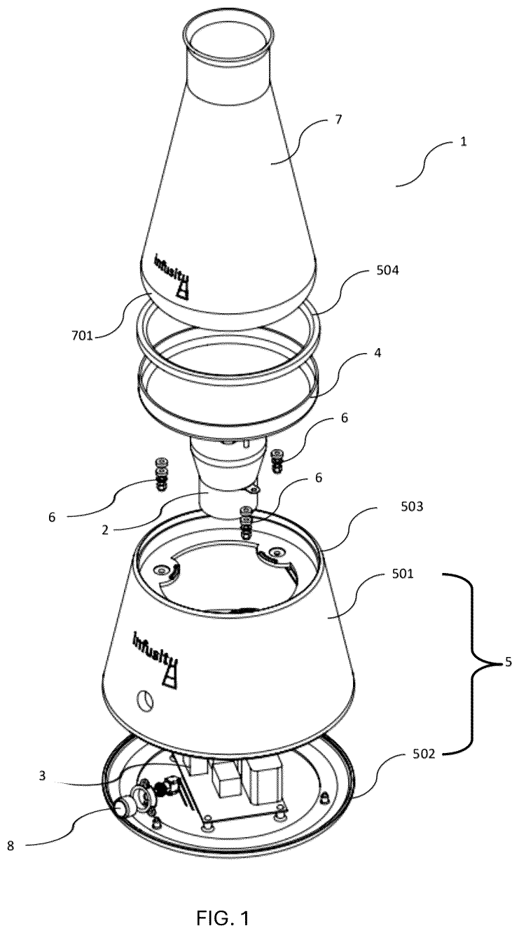

FIG. 1 illustrates an exploded view of an example of a device according to the invention;

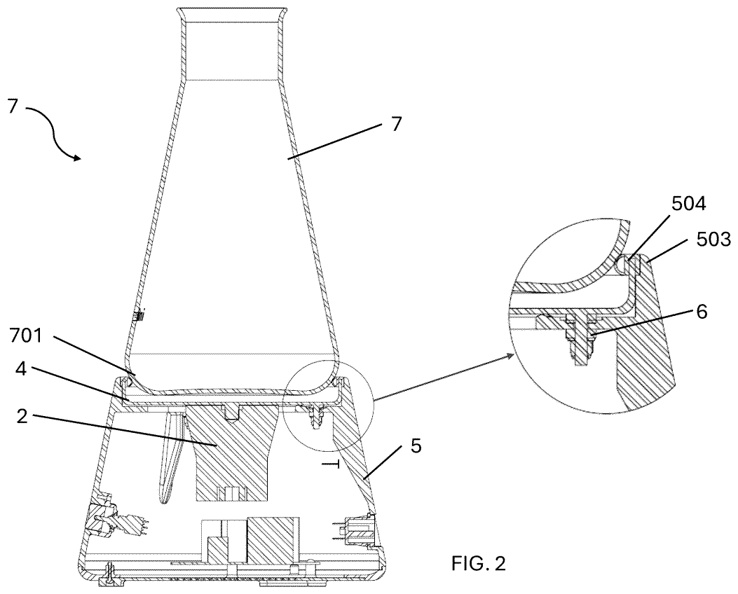

FIG. 2 is a sectional view of the device of FIG. 1;

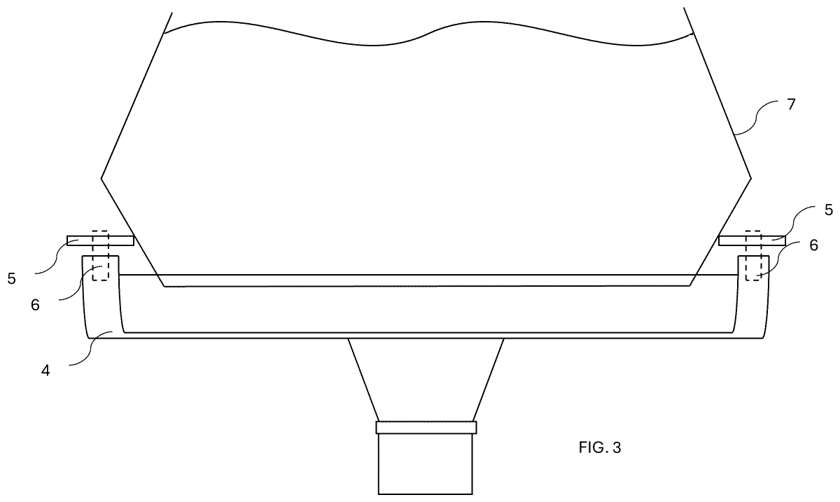

FIG. 3 is a sectional view of another example of a device according to the invention in which the vibration absorption means are on the walls of the basin;

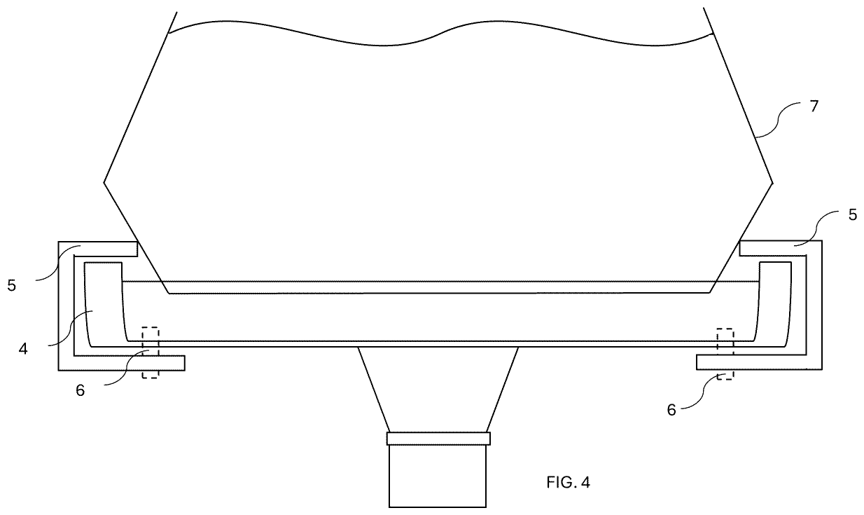

FIG. 4 is a sectional view of another example of a device according to the invention in which the vibration absorption means are below the basin;

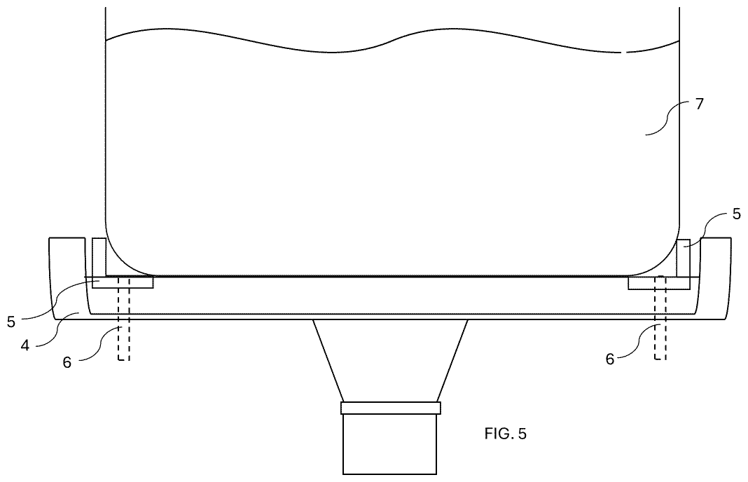

FIG. 5 is a cross-sectional view of another example of a device according to the invention, in which the vibration-absorbing means are in the basin.

With reference to FIGS. 1 and 2, an ultrasonic infusion device 1 according to the invention comprises an ultrasonic wave generator 2, which is here a piezoelectric transducer comprising electrodes placed on either side of a piezoelectric material. The generator 2 is electrically connected to an electronic card 3 as is well known to a person skilled in the art. A basin 4, designed to be filled with an ultrasound-conducting liquid, is made of 304L stainless steel. Its bottom face is connected by glueing and screwing to the upper surface of generator 2 to form a rigid assembly 2;4. A housing 5 comprises here a tronconical upper part 501 surrounding the generator 2, the electronical card 3 and the basin 4, and a lower part 502, which serves as a base. The two parts 501 and 502 are screwed together.

The upper part 501 of the housing 5 comprises an internal ring wherein holes are made to accommodate bumpers 6 which are also connected to flanges protruding from the rigid assembly 2;4 (from the wave generator 2), in order to act as vibration absorbers between the rigid assembly and the housing.

The top edge 503 of housing 5 surrounds the walls of basin 4, leaving a layer of air to prevent the loss of ultrasound. To place the infusion container 7 on the housing 5 without the risk of it slipping and falling off, a soft and gripping rubber seal 504 is placed on the top edge 503 of the housing 5. The seal 504 has a groove into which the basin 4 is inserted to prevent ultrasound-conducting liquid from seeping between the housing 5 and the basin 4 and damaging the electrical components. In addition, the seal 504 is hollow to prevent ultrasound being lost through it. The infusion container 7 is made of glass and is of conical shape, more particularly in the shape of an Erlenmeyer in order to concentrate the ultrasound towards the centre of the container 7. Its base 701 is dimensioned to be supported by the housing 5 and the seal 504 at its edge 503. In addition, the base 701 of the container 7 is flat with a rounded edge so that the flat part is in continuous contact with the ultrasound-conducting liquid in the basin 4 while the rounded edge rests on the housing.

The base 701 of the container 7 is here sandblasted, so that it becomes transparent when it comes into contact with the ultrasound-conducting liquid. For the convenience of the user, the ultrasonic conductive liquid is intended to be water.

For example, the infusion container 7 is designed to contain 2 L of liquid, for example water with edible ingredients such as fruit and vegetables. The power of the generator 2 is 60 W/L for optimal infusion without the risk of heating the liquid in the container 7, i.e. a power of 120 W. The device includes an ON/OFF button 8 to activate or deactivate generator 2.

FIG. 3 shows another example of a device according to the invention in which the vibration absorbing means 6 are mounted on the walls of the basin 4 and in which the container carrier is connected to the vibration absorbing means 6.

According to another example, shown in FIG. 4, the vibration absorbing means are mounted under the basin 4 and the container carrier 5 is connected to these vibration absorbing means 6 under the basin 4 and rises above the basin 4 so that the infusion container 7 can be placed there.

In another example, illustrated in FIG. 5, the vibration absorption means 6 are mounted in the basin 4 and connected to the container carrier 5, which can be a ring partially immersed in the basin or a plurality of suitably shaped pads. The container has here a classical cylindrical shape.

As obvious for a person skilled in the art, the various features illustrated in these examples can be combined.

1. An ultrasonic infusion device comprising:
An ultrasonic wave generator,
A basin physically connected to the ultrasonic wave generator to form a rigid assembly and wherein said basin is arranged to comprise an ultrasound-conducting liquid, and
An infusion container comprising a base,
wherein the device further comprises vibration absorbing means which are mounted between the rigid assembly and a container carrier, and wherein the base of the infusion container is dimensioned to be supported by the container carrier and is shaped to ensure continuous contact with the ultrasound-conducting liquid.

2. An ultrasonic infusion device according to claim 1, wherein the basin is physically connected to the ultrasonic wave generator by screwing and/or gluing.

3. An ultrasonic infusion device according to claim 1, wherein the basin is made of stainless steel, preferably 304L stainless steel.

4. An ultrasonic infusion device according to claim 1, wherein the vibration absorbing means comprise seals, bumpers and/or dampers.

5. An ultrasonic infusion device according to claim 1, wherein the infusion container is of conical shape, preferably of Erlenmeyer shape.

6. An ultrasonic infusion device according to claim 1, wherein the base of the infusion container has a rounded edge, such that when the said rounded edge rests on the container carrier, the base of the infusion container lies at a non null height above the bottom of the basin, but below the top edge of the basin.

7. An ultrasonic infusion device according to claim 6, wherein, in operation mode, the base of the infusion container lies between 1 mm and 10 mm above the bottom of the basin and is in continuous contact with ultrasound conducting liquid added in the basin.

8. An ultrasonic infusion device according to claim 1, wherein the outer surface of the base of the infusion container is sandblasted.

9. An ultrasonic infusion device according to claim 1, wherein the container carrier is part of a housing that encloses the rigid assembly and comprises a top opening defined by a top edge.

10. An ultrasonic infusion device according to claim 9, wherein the top edge of the housing surrounds the walls of the basin without touching them so that a layer of air remains between the basin and the housing.

11. An ultrasonic infusion device according to claim 1, wherein the container carrier comprises a grippy and soft surface for the infusion container to be placed on.

12. An ultrasonic infusion device according to claim 11, wherein the grippy and soft surface is a seal (504).

13. An ultrasonic infusion device according to claim 12, wherein the seal is designed to accommodate the top edge of the basin.

14. An ultrasonic infusion device according to claim 12, wherein the seal is hollow.

15. An ultrasonic infusion device according to claim 1, wherein the ultrasound-conducting liquid is water.

16. An ultrasonic infusion device according to claim 1, wherein the power of the ultrasonic wave generator is comprised between 10 and 150 W/L per litre of liquid contained in the infusion container.
